(19) United States
(12) Patent Application Publication
(10) Pub. No.: US 2025/0002358 A1
(43) Pub. Date: Jan. 2, 2025

(54) MANUFACTURING METHOD OF SILICON NANOPARTICLES FOR BATTERIES AND SILICON-DOPED ELECTRODE MATERIAL

(71) Applicant: NAN YA PLASTICS CORPORATION, TAIPEI (TW)

(72) Inventors: Te-Chao Liao, TAIPEI (TW); Wei-Sheng Cheng, TAIPEI (TW); Chao-Tung Wu, TAIPEI (TW); Hsin-Hui Chiu, TAIPEI (TW)

(73) Assignee: NAN YA PLASTICS CORPORATION, TAIPEI (TW)

(21) Appl. No.: 18/464,274

(22) Filed: Sep. 11, 2023

(30) Foreign Application Priority Data
Jun. 28, 2023 (TW) 112124064

(51) Int. Cl. C01B 33/021; H01M 4/04; H01M 4/62

(52) U.S. Cl. CPC C01B 33/021; H01M 4/0471; H01M 4/62; B82Y 30/00; B82Y 40/00; C01P 2004/64

(57) ABSTRACT

Manufacturing methods of silicon nanoparticles for batteries and silicon-doped electrode material, wherein the manufacturing method of silicon nanoparticles for batteries includes the following steps. A dispersant is mixed with a solvent to form a dispersion liquid. Then, the dispersion liquid, a grinding medium and a silicon raw material are added into a grinder. A grinding process is performed to form silicon nanoparticles with an average particle size of less than 200 nm. Next, a silicon dispersion liquid containing the silicon nanoparticles is taken out. Afterward, alkali solution is added into the silicon dispersion liquid to form silicon nanoparticles for batteries, wherein surface layers of the silicon nanoparticles for batteries each is a silicon oxide layer.

### CROSS-REFERENCE TO RELATED APPLICATION

This application claims the priority benefit of Taiwan application serial no. 112124064, filed on Jun. 28, 2023. The entirety of the above-mentioned patent application is hereby incorporated by reference herein and made a part of this specification.

### BACKGROUND

### Technical Field

The disclosure relates to a manufacturing method of electrode material, and more particularly, to a manufacturing method of silicon nanoparticles for batteries and silicon-doped electrode materials.

### Description of Related Art

Currently, graphite is the mainstream anode material for commercial lithium-ion batteries. However, the development of this material has approached its theoretical capacity of 372 milliampere-hours per gram (mAh/g). For future applications requiring high energy density, the space that graphite can provide is quite limited.

Silicon-based anodes, as the most promising next-generation anode materials, have the advantage of high theoretical capacity (4200 mAh/g). However, silicon undergoes severe volume expansion during the charging and discharging process, leading to material pulverization and poor cycle life. Thus, silicon cannot be used alone to form negative electrodes. Silicon is often mixed with graphite materials to form the silicon-doped carbon electrode. Moreover, considering the stability of the battery, the silicon content is about 3 to 5% of the total weight of the silicon-doped carbon electrode material.

Among the known solutions, a common method is to minimize the size of the silicon material using nanotechnology, so as to control the volume expansion of silicon material by using nanoscale silicon. Silicon materials on the market are available in sizes ranging from 10 to 300 nanometers (nm), but they are expensive. In addition, nanoscale silicon materials are prone to agglomeration into larger particles, which makes it more difficult to uniformly mix silicon and other materials in the process of manufacturing electrodes.

Therefore, improving the existing process to produce silicon materials that alleviate the volume expansion problem and enhance the cycle life of silicon-doped electrode materials is a goal urgently sought by the industry.

### SUMMARY

The present disclosure provides a manufacturing method of silicon nanoparticles for battery and silicon-doped electrode materials, wherein the silicon nanoparticles for batteries have the advantage of mitigating volume expansion, thereby enhancing the capacitance retention rate of silicon-doped electrode materials undergoing multiple charge-discharge cycles.

A manufacturing method of silicon nanoparticles for batteries in the present disclosure includes the following steps: mixing a dispersant with a solvent to form a dispersion liquid; adding the dispersion liquid, a grinding medium and a silicon raw material into a grinder; performing a grinding process to form silicon nanoparticles with an average particle size of less than 200 nm; taking out a silicon dispersion liquid containing the silicon nanoparticles; and adding an alkali solution to the silicon dispersion liquid to form silicon nanoparticles for batteries, wherein surface layers of the silicon nanoparticles for batteries each is a silicon oxide layer.

In an embodiment of the present disclosure, the silicon raw material is a recycled silicon material.

In an embodiment of the present disclosure, the dispersant is at least one selected from polyethylene glycol, polyvinyl pyrrolidone, triethylhexyl phosphoric acid, sodium lauryl sulfate, methylpentanol, cellulose derivatives, polyacrylamide and polyethylene glycol fatty acid.

In an embodiment of the present disclosure, the solvent is water, alcohol solvent or ketone solvent.

In an embodiment of the present disclosure, an addition amount of the dispersant added to the grinder is 10 to 50 parts by weight based on 100 parts by weight of an addition amount of the silicon raw material.

In an embodiment of the present disclosure, a shape of the grinding medium is spherical, and the grinding medium has an average particle diameter of 100 to 500 nm.

In an embodiment of the present disclosure, an addition amount of the grinding medium is 100 to 500 parts by weight based on 100 parts by weight of an addition amount of the silicon raw material.

In an embodiment of the present disclosure, the alkali solution is a lithium hydroxide solution, a sodium hydroxide solution or a potassium hydroxide solution.

In an embodiment of the present disclosure, an addition amount of the alkali solution is 0.1 to 5 parts by weight based on 100 parts by weight of an addition amount of the silicon nanoparticles.

In an embodiment of the present disclosure, the grinding process is a wet ball grinding method, and a grinding time of the grinding process is 2 to 6 hours.

In an embodiment of the present disclosure, a ratio of a particle size of the silicon nanoparticle for batteries to a thickness of the silicon oxide layer is 3:1 to 40:1.

In an embodiment of the present disclosure, the silicon oxide layer has a thickness of 5 to 30 nm.

A manufacturing method of a silicon-doped electrode material in the present disclosure includes the following steps: providing the silicon nanoparticles for batteries obtained by the manufacturing method according to claim 1; mixing the silicon nanoparticles for batteries with an active material; and performing spray granulation and calcining to obtain the silicon-doped electrode material, wherein the active material is carbon material, metal element or metal alloy compound.

In an embodiment of the present disclosure, based on a total weight of the silicon-doped electrode material, a content of the silicon nanoparticles for batteries is 1 to 40% by weight.

To sum up, in the manufacturing method of silicon nanoparticles for batteries in this disclosure, through the addition of a dispersant, the silicon nanoparticles are not easy to coalesce and agglomerate, thereby improving the grinding efficiency and promoting the miniaturization of silicon raw materials. Through the addition of the alkali solution, a silicon oxide layer can be formed on the surface of the silicon nanoparticles for batteries, thereby suppressing the volume expansion of the silicon nanoparticles for batteries. The silicon-doped electrode material prepared with the above-mentioned silicon nanoparticles for batteries can effectively improve the capacitance retention rate of silicon-doped electrode materials undergoing multiple charge-discharge cycles.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flowchart of the manufacturing method for silicon nanoparticles for batteries in the present disclosure.

FIG. 2A is an electronic image of a silicon-doped carbon electrode material slice in the present disclosure.

FIG. 2B is an analysis of the elemental composition of the parts circled in FIG. 2A.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

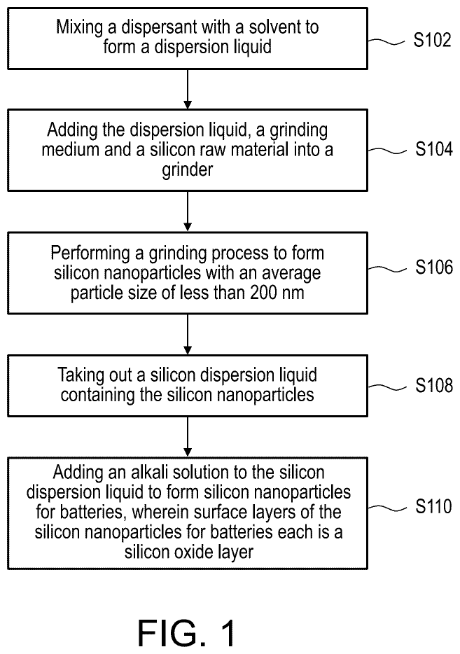

FIG. 1 is a flowchart of the manufacturing method for silicon nanoparticles for batteries in the present disclosure. Please refer to FIG. 1, step S102 is executed: mixing a dispersant with a solvent to form a dispersion liquid. The dispersant may be, for example, an organic dispersant. Specifically, the dispersant can be at least one selected from polyethylene glycol, polyvinyl pyrrolidone, triethylhexyl phosphoric acid, sodium lauryl sulfate, methylpentanol, cellulose derivatives, polyacrylamide and polyethylene glycol fatty acid, but is not limited thereto. The dispersant may also be, for example, a high molecular polymer, such as polyethylene glycol or polyvinyl pyrrolidone. The solvent may be, for example, water, alcohol solvent, or ketone solvent.

Next, step S104 is executed: adding the dispersion liquid, a grinding medium, and a silicon raw material into a grinder. In this embodiment, the prepared dispersion liquid and the grinding medium are added into the grinder together, and then the silicon raw material is added. In some other embodiments, the dispersion liquid, the grinding medium, and the silicon raw material can also be added to the grinder together. The order of adding to the grinder is not limited in the present disclosure.

In this embodiment, the silicon raw material can be regenerated silicon processed by the purification and recovery process of silicon waste. Silicon waste may be, for example, waste solar cells, IC boards, silicon wafer waste, memory cards, and the like. Since the silicon raw material is recycled silicon material, it has the advantages of being environmentally friendly and low cost.

The grinding medium is used to grind the silicon raw material into silicon nanoparticles. The shape, size, and material of the grinding media are related to the properties of the material to be ground, the requirements for feeding, and product particle size. In this embodiment, the shape of the grinding medium may be, for example, spherical, the average particle diameter (D₅₀) may be, for example, 100 nanometers (nm) to 500 nm, and the material may be, for example, zirconia, but not limited thereto. The amount of grinding medium added is related to the size of the grinding chamber in the grinder and the amount of the material being ground. In some embodiments, an addition amount of the grinding medium may be, for example, 100 to 500 parts by weight based on 100 parts by weight of an addition amount of the silicon raw material. When the addition amount of the grinding medium is within the above range, the silicon raw material can be effectively ground into silicon nanoparticles with a desired particle size (for example, the particle size can be less than 200 nm) in subsequent steps. When the addition amount of grinding medium is less than 100 parts by weight, the area where the grinding medium can contact the material to be ground is less, which may take a lot of grinding time and the grinding effect is not good. When the addition amount of grinding medium is more than 500 parts by weight, in order to avoid damage to the machine during grinding, the dispersion liquid must be excessively diluted to fill the grinding chamber, which does not meet the solid content required for practical applications. The dispersant can be used to disperse silicon nanoparticles to prevent them from agglomerating and prevent the overall viscosity from becoming too high to continue grinding, which helps to improve grinding efficiency. In some embodiments, an addition amount of the dispersant added to the grinder may be, for example, 10 to 50 parts by weight based on 100 parts by weight of an addition amount of the silicon raw material. In some other embodiments, preferably, the addition amount of the dispersant added to the grinder may be, for example, 20 to 40 parts by weight based on 100 parts by weight of the addition amount of the silicon raw material. When the addition amount of the dispersant is less than 10 parts by weight, the effect of preventing silicon nanoparticles from agglomerating may not be good. When the addition amount of the dispersant exceeds 50 parts by weight, it may make subsequent purification difficult.

Next, step S106 is executed: performing a grinding process to form silicon nanoparticles with an average particle size of less than 200 nm. In this embodiment, the grinding process is a wet ball grinding method, and the grinding time can be adjusted depending on the desired particle size. Specifically, a particle size analyzer can be used to measure the average particle size of the current silicon particles during the grinding process. In some embodiments, the grinding time may be, for example, 2 to 6 hours (h), but is not limited thereto. In addition, the dispersion liquid can also be added during the grinding process to improve grinding efficiency. Here, the total addition amount of dispersant (i.e., the sum of the addition amounts of the dispersant added into the grinder before and during grinding) does not exceed 50% by weight of the silicon raw material.

Next, step S108 is executed: taking out a silicon dispersion liquid containing the silicon nanoparticles.

Next, step S110 is executed: adding an alkali solution to the silicon dispersion liquid to form silicon nanoparticles for batteries, wherein surface layers of the silicon nanoparticles for batteries each is a silicon oxide layer. In this embodiment, the alkali solution can oxidize the surface layers of the silicon nanoparticles to form the silicon nanoparticles for batteries with the silicon oxide layers on the surfaces. In some embodiments, the thickness of the oxide layer on the surface of the silicon nanoparticle for batteries may be, for example, 5 to 30 nm. The silicon oxide layer on the surface of silicon nanoparticle for batteries can inhibit the volume expansion of the silicon inside, thereby enabling the electrode formed by doping silicon nanoparticles for batteries with other active materials (such as carbon materials, metal elements, or metal compounds) to maintain its capacitance undergoing multiple charge-discharge cycles. So far, the manufacture of silicon nanoparticles for batteries has been completed. This drastic volume expansion will lead to silicon pulverization and breakage and detachment from the plate, resulting in capacity loss and poor cycle life.

In detail, silicon has a theoretical capacity of up to 4200 mAh/g, but the main reason why silicon electrode has not yet been commercialized is that when lithium and silicon form a lithium-silicon alloy phase, the volume expands to 300 to 400% of the original volume. This drastic volume expansion will lead to silicon pulverization and detachment from the plate, resulting in capacity loss and poor cycle life. The theoretical capacitance of silicon oxide is 1547 mAh/g. Although the capacitance of silicon oxide is not as high as that of silicon, the volume expansion of silicon oxide (about 134%) is smaller than that of silicon. And silicon oxide has a better capacitance retention rate. In the present disclosure, the surface layer of the silicon nanoparticle can be oxidized into a silicon oxide layer by adding a small amount of lye, thereby suppressing the volume expansion of silicon and improving the capacitance retention rate.

In some embodiments, the alkali solution may be, for example, a lithium hydroxide solution, a sodium hydroxide solution, or a potassium hydroxide solution, and the pH value of the alkali solution is 8 to 13. In some embodiments, an addition amount of the alkali solution may be, for example, 0.1 to 5 parts by weight based on 100 parts by weight of an addition amount of the silicon nanoparticles. In some other embodiments, preferably, the addition amount of the alkali solution may be, for example, 0.5 to 2 parts by weight based on 100 parts by weight of the addition amount of the silicon nanoparticles. The addition amount of the alkali solution is related to the thickness of the silicon oxide layers on the surfaces of the silicon nanoparticles for batteries. When the addition amount of alkali solution is less than 0.1 parts by weight, the oxidation effect on silicon nanoparticles is almost negligible. When the addition amount of alkali solution is greater than 5 parts by weight, the thickness of the silicon oxide layer will increase (more silicon will be oxidized). Although the increase in the thickness of the oxide layer can more effectively suppress the volume expansion of the silicon, since the capacitance of the silicon oxide is smaller than that of silicon, the capacitance of the subsequently formed silicon-doped electrode material is significantly reduced. When the addition amount of the alkali solution is within the above range, the silicon-doped electrode material can simultaneously have high capacitance and excellent capacitance retention rate. At this time, a ratio of the particle size of the silicon nanoparticle for batteries to the thickness of the silicon oxide layer may be, for example, 3:1 to 40:1.

In the present disclosure, silicon nanoparticles for batteries can be mixed with electrode active materials to form silicon-doped electrode materials. Specifically, the manufacturing method of the silicon-doped electrode material may include the following steps. The above-mentioned silicon nanoparticles for batteries are provided. Next, the silicon nanoparticles for batteries and active material are mixed. Then, spray granulation and calcining are carried out to obtain silicon-doped electrode materials. In some embodiments, the active material may be, for example, a carbon material, a metal element, or a metal compound. The carbon material can be graphite or other carbon sources, the metal element can be tin, nickel, titanium, manganese, copper, or magnesium, and the metal compound can be titanium carbide or titanate, but is not limited thereto.

The silicon-doped electrode material can be used as the negative electrode of the battery. The calcining step is carried out after injecting an inert gas, wherein the inert gas may be, for example, argon, and the calcining temperature may be, for example, 700 to 900 degrees. In the present disclosure, through the calcining step, the dispersant/organic substance can be effectively cracked and removed to prevent it from affecting the electrical properties of the electrode material.

In some embodiments, based on the total weight of the silicon-doped electrode material, the content of the silicon nanoparticles for batteries is 1 to 40% by weight. When the content of silicon nanoparticles for batteries is less than 1% by weight, because the content is too small, it is equivalent to not doping silicon in the battery material, so that the improvement effect of the capacitance of the electrode material is not good. When the content of the silicon nanoparticles used in the battery is greater than 40% by weight, the stability of the battery may decrease.

The following embodiments are provided to illustrate the manufacturing method of silicon nanoparticles for battery and silicon-doped electrode materials of the present disclosure. However, the following embodiments are not intended to limit the scope of the present disclosure.

### EMBODIMENT

In order to demonstrate that the silicon nanoparticles for batteries proposed by the present disclosure can effectively maintain the capacity of the electrode, the following specific embodiments are provided.

### Embodiment 1. Relationship Between the Average Particle Size of Silicon Nanoparticles, the Addition Amount of Dispersant, and the Grinding Time

### 1.1. Preparation of Silicon Nanoparticles for Batteries

A dispersant (polyethylene glycol and polyvinyl pyrrolidone) is dissolved in water to form a dispersion liquid. Next, the dispersion liquid and a grinding medium are fed into a grinder together, and a silicon raw material is added for grinding to form silicon nanoparticles. Subsequently, a silicon dispersion liquid after grinding is discharged and taken out, and a suitable amount of an alkali solution (lithium hydroxide) is added to mix and react to prepare silicon nanoparticles for batteries in Examples 1-5. The addition amounts of the silicon raw material, the dispersant, the grinding medium, and the alkali solution, as well as the grinding time, are shown in Table 1.

### 1.2. Measurement of Average Particle Sizes and Results

An average particle size (D₅₀) of the silicon nanoparticles for batteries in Examples 1-5 was measured using a particle size analyzer, and the results are shown in Table 1.

TABLE 1

| | Example 1 | Example 2 | Example 3 | Example 4 | Example 5 |
|---|---|---|---|---|---|
| Silicon | 100 | 100 | 100 | 100 | 100 |
| raw material | | | | | |
| (parts | | | | | |
| by weight) | | | | | |
| Dispersant | 10 | 20 | 30 | 40 | 50 |
| (parts | | | | | |
| by weight) | | | | | |
| Grinding | 450 | 450 | 450 | 450 | 450 |
| medium | | | | | |
| (parts | | | | | |
| by weight) | | | | | |
| Grinding | 2 | 3 | 4 | 5 | 6 |
| time | | | | | |
| (hr) | | | | | |
| Alkali | 0.5 | 0.5 | 0.5 | 0.5 | 0.5 |
| solution | | | | | |
| (parts | | | | | |
| by weight) | | | | | |
| Average | 176 | 118 | 84 | 65 | 52 |
| particle size | | | | | |
| (D₅₀) (nm) | | | | | |

As can be seen from Table 1, with the increase in addition amount of dispersant and the extension of grinding time, the average particle size of the silicon nanoparticles for batteries can be gradually reduced.

### Embodiment 2. Elemental Analysis of Silicon-Doped Carbon Electrode Material

### 2.1. Preparation of Silicon-Doped Carbon Electrode Materials

The silicon nanoparticles for batteries in Example 1 are mixed with graphite and then subjected to spray granulation. Next, an inert gas (argon) is introduced and calcining is performed to obtain the silicon-doped carbon electrode material of Example 6.

### 2.2. TEM-EDS Analysis and Results

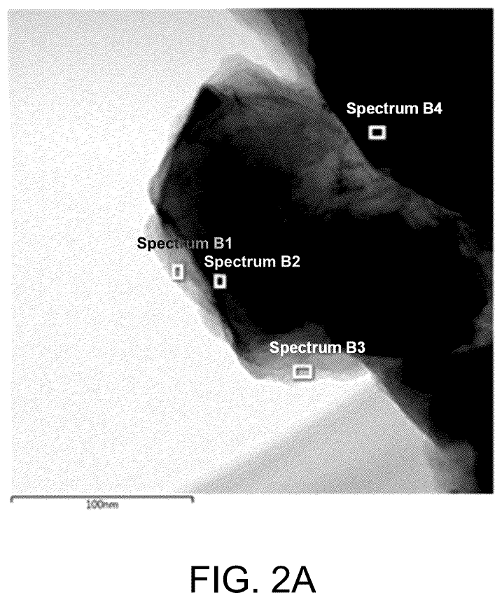

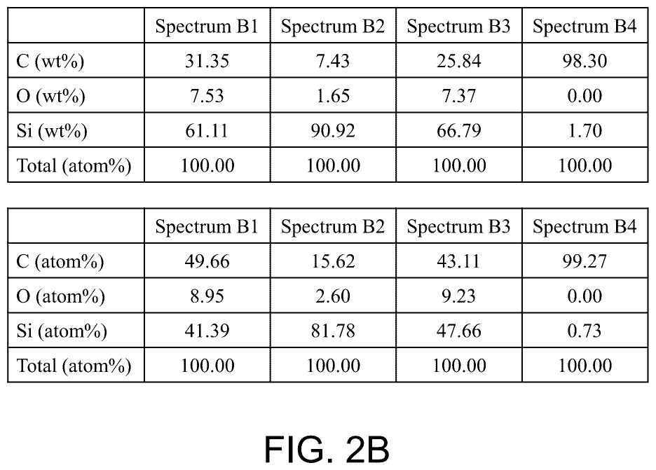

The silicon-doped carbon electrode material of Example 6 is slicing. Next, the structural and elemental analysis was carried out by transmission electron microscopy-energy dispersive X-ray spectroscopy (TEM-EDS), and the results are shown in FIG. 2A and FIG. 2B.

FIG. 2A is an electronic image of a silicon-doped carbon electrode material slice in the present disclosure. FIG. 2B is an analysis of the elemental composition of the parts circled in FIG. 2A. Please refer to FIG. 2A and FIG. 2B at the same time. Since the content of silicon (Si) is relatively high compared to the content of oxygen (O), and the silicon lattice image can be observed under a high-resolution image, it can be deduced that silicon is only partially oxidized, and carbon (C) and silicon form a composite structure of alternating stacks.

### Embodiment 3. Capacity Retention Rate of Silicon-Doped Carbon Negative Half-Cell

### 3.1. Half-Cell Assembly

By adjusting the addition amount of alkali solution (as shown in Table 2), the silicon-doped carbon electrode materials containing silicon nanoparticles for batteries with different oxidation degrees are prepared, wherein the doped amount of silicon nanoparticles for the batteries is 20% by total weight of the silicon-doped carbon electrode material. Taking the preparation of the half-cell of Example 7 as an example, the silicon-doped carbon electrode material is mixed with a conductive agent, a binder, and a solvent to form a slurry. Next, the slurry is coated on the current collector, followed by drying, rolling, and slitting processes to form a silicon-doped carbon negative electrode. Then, the silicon-doped carbon negative electrode is assembled with lithium metal, separator, and electrolyte to form a half-cell of Example 7. The fabrication methods of the half-cells of Comparative Example and Example 8 are similar to the half-cells of Example 7, the difference is that: the Comparative Example uses non-oxidized silicon nanoparticles, and Example 8 uses the silicon nanoparticles for batteries with a higher degree of oxidation than Example 7 (meaning that the thickness of the silicon oxide layer in Example 8 is greater than that of the silicon oxide layer in Example 7).

### 3.2. Capacitance Analysis and Results

### 3.2.1. Activation Test

The silicon-doped carbon negative half-cell was subjected to three charge-discharge cycles at a constant current rate of 0.1 C. From the data of the first charge-discharge cycle, the first discharge capacitance, the first charge capacitance, and the first coulombic efficiency can be obtained. The results are shown in Table 2.

### 3.2.2. Cycle Life Test

The silicon-carbon negative half-cell is subjected to 200 charge-discharge cycles at a constant current rate of 0.5 C, and the capacity retention rate is calculated. The results are shown in Table 2.

TABLE 2

| | Comparison | | |
|---|---|---|---|
| | Example | Example 7 | Example 8 |
| Silicon nanoparticles | 100 | 100 | 100 |
| (parts by weight) | | | |
| Alkali solution | 0 | 5 | 15 |
| (parts by weight) | | | |
| The first | 1140 | 882 | 653 |
| discharge capacitance | | | |
| (mAh/g) | | | |
| The first charge capacitance | 958 | 675 | 489 |
| (mAh/g) | | | |
| The first coulombic efficiency | 84 | 77 | 75 |
| (%) | | | |
| Capacity retention rate after 200 | 78 | 96 | 98 |
| charge-discharge cycles (%) | | | |

It can be seen from Table 2 that when the silicon surface layer does not have a silicon oxide layer (Comparison Example), the first discharge/charge capacity of the silicon-doped carbon electrode formed is higher than that of Examples 7 and 8 with silicon oxide layer on the silicon surface layer. This is because the capacitance of silicon oxide is lower than that of silicon, so after forming silicon-doped carbon electrodes, the overall capacitance will be low. In addition, it can be seen from Table 2 that after 200 charge-discharge cycles, the capacity retention rate of the silicon-doped carbon electrodes (with a silicon oxide layer on the silicon surface) of Examples 7 and 8 is higher than that of the silicon-doped carbon electrodes of Comparative Example (There is no silicon oxide layer on the silicon surface), and the capacity maintenance rate is related to the thickness of the silicon oxide layer on the silicon surface, which shows that the silicon oxide layer on the silicon surface can effectively inhibit the volume expansion of the internal silicon. In summary, in the manufacturing method for silicon nanoparticles for batteries of the present disclosure, through the addition of a dispersant, the silicon nanoparticles are not easy to coalesce and agglomerate, avoiding excessive viscosity and affecting grinding, thereby promoting silicon Raw material miniaturization. Through the addition of an alkali solution, the surface of silicon nanoparticles for batteries can have a silicon oxide layer, which can inhibit the volume expansion of silicon nanoparticles for batteries. The silicon-doped electrode material prepared by the silicon nanoparticles for batteries of the present disclosure can effectively improve its capacity retention rate under multiple charge-discharge cycles.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A manufacturing method of silicon nanoparticles for batteries, comprising:
mixing a dispersant with a solvent to form a dispersion liquid;
adding the dispersion liquid, a grinding medium, and a silicon raw material into a grinder;
performing a grinding process to form silicon nanoparticles with an average particle size of less than 200 nm;
taking out a silicon dispersion liquid containing the silicon nanoparticles; and
adding an alkali solution to the silicon dispersion liquid to form silicon nanoparticles for batteries, wherein surface layers of the silicon nanoparticles for batteries each is a silicon oxide layer.

2. The manufacturing method according to claim 1, wherein the silicon raw material is a recycled silicon material.

3. The manufacturing method according to claim 1, wherein the dispersant is at least one selected from polyethylene glycol, polyvinyl pyrrolidone, triethylhexyl phosphoric acid, sodium lauryl sulfate, methylpentanol, cellulose derivatives, polyacrylamide and polyethylene glycol fatty acid.

4. The manufacturing method according to claim 1, wherein the solvent is water, alcohol solvent or ketone solvent.

5. The manufacturing method according to claim 1, wherein an addition amount of the dispersant added to the grinder is 10 to 50 parts by weight based on 100 parts by weight of an addition amount of the silicon raw material.

6. The manufacturing method according to claim 1, wherein a shape of the grinding medium is spherical, and the grinding medium has an average particle diameter of 100 to 500 nm.

7. The manufacturing method according to claim 1, wherein an addition amount of the grinding medium is 100 to 500 parts by weight based on 100 parts by weight of an addition amount of the silicon raw material.

8. The manufacturing method according to claim 1, wherein the alkali solution is a lithium hydroxide solution, a sodium hydroxide solution or a potassium hydroxide solution.

9. The manufacturing method according to claim 1, wherein an addition amount of the alkali solution is 0.1 to 5 parts by weight based on 100 parts by weight of an addition amount of the silicon nanoparticles.

10. The manufacturing method according to claim 1, wherein the grinding process is a wet ball grinding method, and a grinding time of the grinding process is 2 to 6 hours.

11. The manufacturing method according to claim 1, wherein a ratio of a particle size of the silicon nanoparticle for batteries to a thickness of the silicon oxide layer is 3:1 to 40:1.

12. The manufacturing method according to claim 1, wherein the silicon oxide layer has a thickness of 5 to 30 nm.

13. A manufacturing method of a silicon-doped electrode material, comprising:
providing the silicon nanoparticles for batteries obtained by the manufacturing method according to claim 1;
mixing the silicon nanoparticles for batteries with an active material; and
performing spray granulation and calcining to obtain the silicon-doped electrode material,
wherein the active material is carbon material, metal element or metal alloy compound.

14. The manufacturing method according to claim 13, wherein based on a total weight of the silicon-doped electrode material, a content of the silicon nanoparticles for batteries is 1 to 40% by weight.
